(19) United States
(12) Patent Application Publication
(10) Pub. No.: US 2014/0149697 A1
(43) Pub. Date: May 29, 2014

(54) Memory Pre-Allocation For Cleanup and Rollback Operations

(71) Applicants: Dirk Thomsen, Heidelberg (DE); Ivan Schreter, Malsch (DE)

(72) Inventors: Dirk Thomsen, Heidelberg (DE); Ivan Schreter, Malsch (DE)

(21) Appl. No.: 13/687,581

(22) Filed: Nov. 28, 2012

(51) Int. Cl. G06F 12/02

(52) U.S. Cl. CPC G06F 12/0284
USPC 711/162; 711/170

(57) ABSTRACT

A plurality of operations are executed using first memory (e.g., heap memory, etc.) in a data storage application. During execution, it is determined that one of the operations cannot be executed due to a lack of available first memory. In response, an emergency allocator assigns pre-allocated emergency memory that is separate and distinct from the first memory to the determined operation. The operation can then be completed using this pre-allocated emergency memory. Related apparatus, systems, techniques and articles are also described.

### TECHNICAL FIELD

The subject matter described herein relates to strategies for performing cleanup or rollback operations in out-of-memory situations using pre-allocated memory.

### BACKGROUND

A transactional database is a database management system in which transactions written on the database are able to be rolled back if they are not completed properly. Transactions typically comprise one or more data-manipulation statements and queries, each reading and/or writing information in the database. After a transaction is begun, the data manipulations and/or queries can be executed, and if no errors occur, then the transaction can be committed (i.e., the results of the transaction can be persisted to the database). If an error occurs, then the transaction is rolled back and terminated (and the results of the transaction are not persisted to the database).

Upon a transaction rollback, required rollback operations are executed. Such rollback operations may require memory allocation which, in turn, can fail due to out-of-memory situations. One solution is to immediately terminate the database process, restart the database from the last savepoint and apply a redo log to restore the state based on logged transactions. However, terminating the database is not feasible for most scenarios.

### SUMMARY

In one aspect, a plurality of operations are executed using first memory (e.g., heap memory, etc.) in a data storage application. During execution, it is determined that one of the operations cannot be executed due to a lack of available first memory. In response, an emergency allocator assigns pre-allocated emergency memory that is separate and distinct from the first memory to the determined operation. The operation can then be completed using this pre-allocated emergency memory.

The operations can comprise rollback operations and/or cleanup operations. The determination that one of the operations cannot be executed using the first memory can based on a thrown exception. The pre-allocated emergency memory can be freed the emergency allocator released after completion of the determined operation.

Each operation can be performed by a separate thread such that the pre-allocated emergency memory is assigned to the corresponding thread for the determined operation. The emergency allocator can, in some implementations, only assigns the pre-allocated emergency memory to one thread at a time.

The data storage application uses shadow paging to write a transactionally-consistent savepoint. Adata backup corresponding to the plurality of executed transactions can include a copy of all data pages contained with a particular savepoint. The data storage application can include an in-memory database.

Computer program products are also described that comprise non-transitory computer readable media storing instructions, which when executed one or more data processor of one or more computing systems, causes at least one data processor to perform operations herein. Similarly, computer systems are also described that may include one or more data processors and a memory coupled to the one or more data processors. The memory may temporarily or permanently store instructions that cause at least one processor to perform one or more of the operations described herein. In addition, methods can be implemented by one or more data processors either within a single computing system or distributed among two or more computing systems.

The subject matter described herein provides many advantages. For example, the current subject matter can help guarantee that rollback of a transaction can be handled without terminating the process at all times. Similar advantages are provided for cleanup operations after commit, which are executed asynchronously after the transaction is committed.

Moreover, binding an emergency allocator to one thread at a time guarantees system operation without crashing/restarting or swapping in out-of-memory situations. In addition, such an arrangement obviates the need to over-allocate emergency memory (i.e., the amount of required and pre-allocated emergency memory can be reduced). Furthermore, the emergency allocator can be used for other purposes such as processing the savepoint and making certain operations guaranteed exception-free

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a diagram illustrating a system including a data storage application;

FIG. 2 is a diagram illustrating details of the system of FIG. 1; and

FIG. 3 is a diagram illustrating selective allocation of pre-allocated emergency memory to threads.

### DETAILED DESCRIPTION

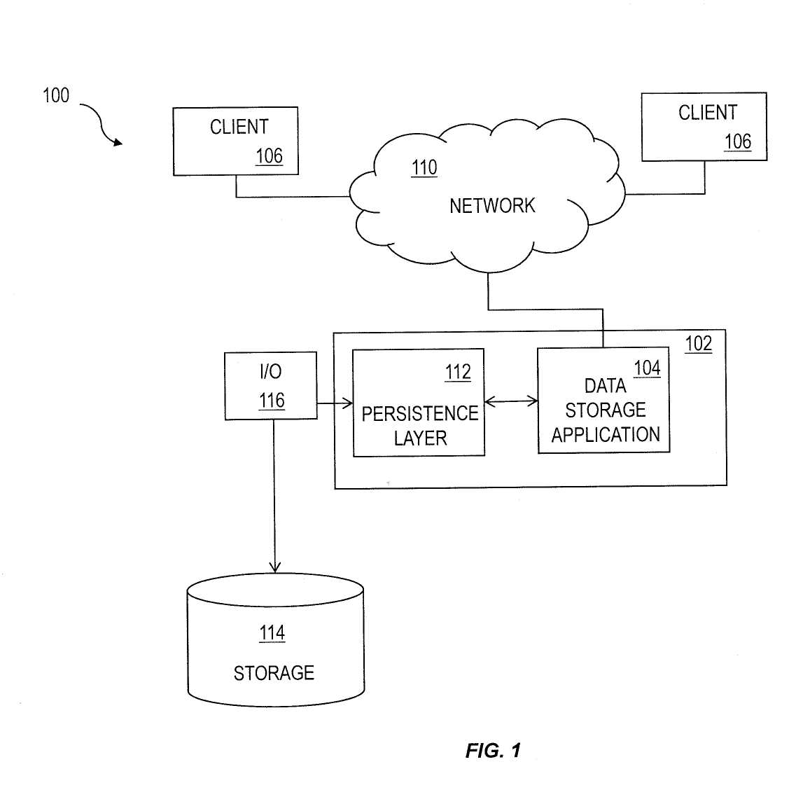

FIG. 1 shows an example of a system 100 in which a computing system 102, which can include one or more programmable processors that can be collocated, linked over one or more networks, etc., executes one or more modules, software components, or the like of a data storage application 104. The data storage application 104 can include one or more of a database, an enterprise resource program, a distributed storage system (e.g. NetApp Filer available from NetApp of Sunnyvale, Calif.), or the like.

The one or more modules, software components, or the like can be accessible to local users of the computing system 102 as well as to remote users accessing the computing system 102 from one or more client machines 106 over a network connection 110. One or more user interface screens produced by the one or more first modules can be displayed to a user, either via a local display or via a display associated with one of the client machines 106. Data units of the data storage application 104 can be transiently stored in a persistence layer 112 (e.g. a page buffer or other type of temporary persistency layer), which can write the data, in the form of storage pages, to one or more storages 114, for example via an input/output component 116. The one or more storages 114 can include one or more physical storage media or devices (e.g. hard disk drives, persistent flash memory, random access memory, optical media, magnetic media, and the like) configured for writing data for longer term storage. It should be noted that the storage 114 and the input/output component 116 can be included in the computing system 102 despite their being shown as external to the computing system 102 in FIG. 1.

Data retained at the longer term storage 114 can be organized in pages, each of which has allocated to it a defined amount of storage space. In some implementations, the amount of storage space allocated to each page can be constant and fixed. However, other implementations in which the amount of storage space allocated to each page can vary are also within the scope of the current subject matter.

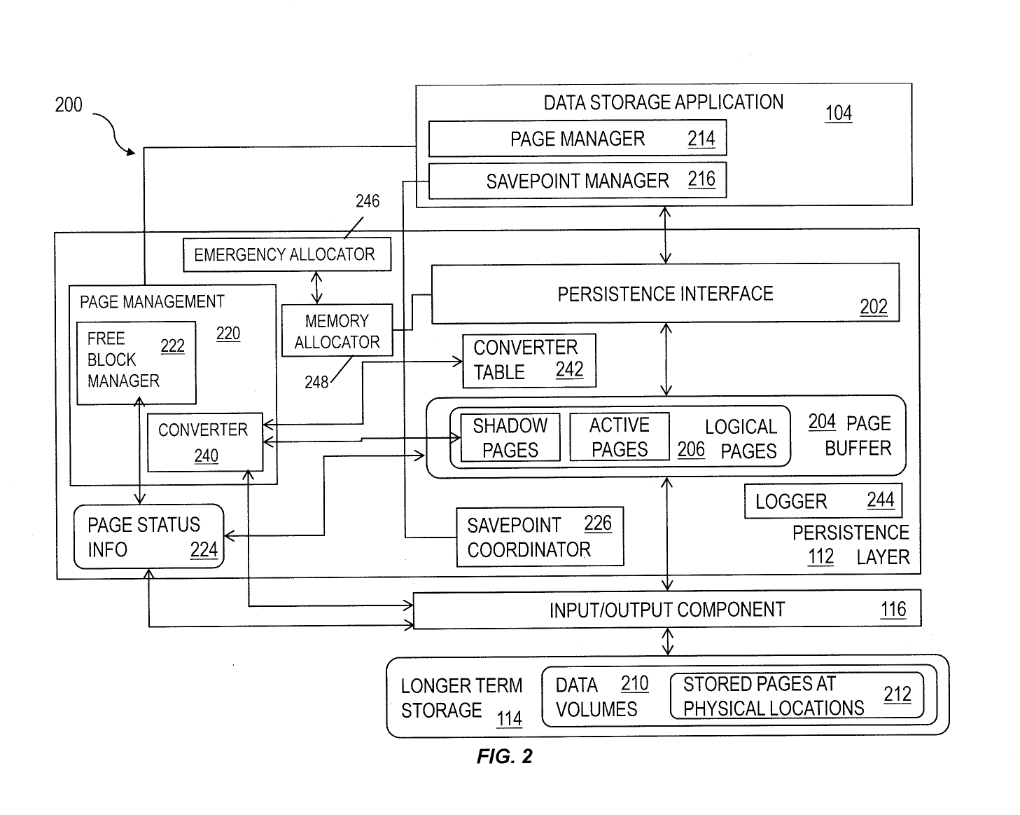

FIG. 2 illustrates a software architecture 200 consistent with one or more features of the current subject matter. A data storage application 104, which can be implemented in one or more of hardware and software, can include one or more of a database application, a network-attached storage system, or the like. According to at least some implementations of the current subject matter, such a data storage application 104 can include or otherwise interface with a persistence layer 112 or other type of memory buffer, for example via a persistence interface 202. A page buffer 204 within the persistence layer 112 can store one or more logical pages 206, and optionally can include shadow pages, active pages, and the like. The logical pages 206 retained in the persistence layer 112 can be written to a storage (e.g. a longer term storage, etc.) 114 via an input/output component 116, which can be a software module, a sub-system implemented in one or more of software and hardware, or the like. The storage 114 can include one or more data volumes 210 where stored pages 212 are allocated at physical memory blocks.

In some implementations, the data storage application 104 can include or be otherwise in communication with a page manager 214 and/or a savepoint manager 216. The page manager 214 can communicate with a page management module 220 at the persistence layer 112 that can include a free block manager 222 that monitors page status information 224, for example the status of physical pages within the storage 114 and logical pages in the persistence layer 112 (and optionally in the page buffer 204). The savepoint manager 216 can communicate with a savepoint coordinator 226 at the persistence layer 204 to handle savepoints, which are used to create a consistent persistent state of the database for restart after a possible crash.

In some implementations of a data storage application 104, the page management module of the persistence layer 112 can implement shadow paging. The free block manager 222 within the page management module 220 can maintain the status of physical pages. The page buffer 204 can included a fixed page status buffer that operates as discussed herein. A converter component 240, which can be part of or in communication with the page management module 220, can be responsible for mapping between logical and physical pages written to the storage 114. The converter 240 can maintain the current mapping of logical pages to the corresponding physical pages in a converter table 242. The converter 240 can maintain a current mapping of logical pages 206 to the corresponding physical pages in one or more converter tables 242. When a logical page 206 is read from storage 114, the storage page to be loaded can be looked up from the one or more converter tables 242 using the converter 240. When a logical page is written to storage 114 the first time after a savepoint, a new free physical page is assigned to the logical page. The free block manager 222 marks the new physical page as “used” and the new mapping is stored in the one or more converter tables 242. In addition, an emergency allocator 246 can be provided that selectively provides access to pre-allocated memory. The emergency allocator 246 can, in some implementations, be coupled to or otherwise communicate with the free block manager 222.

The persistence layer 112 can ensure that changes made in the data storage application 104 are durable and that the data storage application 104 can be restored to a most recent committed state after a restart. Writing data to the storage 114 need not be synchronized with the end of the writing transaction. As such, uncommitted changes can be written to disk and committed changes may not yet be written to disk when a writing transaction is finished. After a system crash, changes made by transactions that were not finished can be rolled back. Changes occurring by already committed transactions should not be lost in this process. A logger component 244 can also be included to store the changes made to the data of the data storage application in a linear log. The logger component 244 can be used during recovery to replay operations since a last savepoint to ensure that all operations are applied to the data and that transactions with a logged “commit” record are committed before rolling back still-open transactions at the end of a recovery process.

With some data storage applications, writing data to a disk is not necessarily synchronized with the end of the writing transaction. Situations can occur in which uncommitted changes are written to disk and while, at the same time, committed changes are not yet written to disk when the writing transaction is finished. After a system crash, changes made by transactions that were not finished must be rolled back and changes by committed transaction must not be lost.

To ensure that committed changes are not lost, redo log information can be written by the logger component 244 whenever a change is made. This information can be written to disk at latest when the transaction ends. The log entries can be persisted in separate log volumes while normal data is written to data volumes. With a redo log, committed changes can be restored even if the corresponding data pages were not written to disk. For undoing uncommitted changes, the persistence layer 112 can use a combination of undo log entries (from one or more logs) and shadow paging.

The persistence interface 202 can handle read and write requests of stores (e.g., in-memory stores, etc.). The persistence interface 202 can also provide write methods for writing data both with logging and without logging. If the logged write operations are used, the persistence interface 202 invokes the logger 244. In addition, the logger 244 provides an interface that allows stores (e.g., in-memory stores, etc.) to directly add log entries into a log queue. The logger interface also provides methods to request that log entries in the in-memory log queue are flushed to disk.

Log entries contain a log sequence number, the type of the log entry and the identifier of the transaction. Depending on the operation type additional information is logged by the logger 244. For an entry of type “update”, for example, this would be the identification of the affected record and the after image of the modified data.

When the data application 104 is restarted, the log entries need to be processed. To speed up this process the redo log is not always processed from the beginning. Instead, as stated above, savepoints can be periodically performed that write all changes to disk that were made (e.g., in memory, etc.) since the last savepoint. When starting up the system, only the logs created after the last savepoint need to be processed. After the next backup operation the old log entries before the savepoint position can be removed.

When the logger 244 is invoked for writing log entries, it does not immediately write to disk. Instead it can put the log entries into a log queue in memory. The entries in the log queue can be written to disk at the latest when the corresponding transaction is finished (committed or aborted). To guarantee that the committed changes are not lost, the commit operation is not successfully finished before the corresponding log entries are flushed to disk. Writing log queue entries to disk can also be triggered by other events, for example when log queue pages are full or when a savepoint is performed.

As stated above, the data storage application 104 can use shadow paging so that the savepoint manager 216 can write a transactionally-consistent savepoint. With such an arrangement, a data backup comprises a copy of all data pages contained in a particular savepoint, which was done as the first step of the data backup process. The current subject matter can be also applied to other types of data page storage.

As noted above, an emergency allocator 246 having associated pre-allocated emergency memory (i.e., pre-defined blocks/section of memory, etc.) can be used. Such pre-allocated memory can be fixed to pre-defined blocks or it can be variable depending on the desired configuration. When an operation such as a cleanup operation (i.e., an operation to remove unused space, etc.) or a rollback operation faces a situation in which there is no longer available memory (which would ordinarily be assigned by the memory allocator 248), an exception (i.e., an error condition) can be thrown outside of the area of affected code and caught outside by a separated portion of code. The emergency allocator 246 can pre-allocates, at process startup, emergency memory from the memory allocator 248 and maintains this memory for emergency purposes. After such an exception, the emergency allocator 246 can be assigned to the corresponding thread and the cleanup/rollback operation will be repeated, with all allocations for such operations using the emergency allocator 246.

Assuming that the pre-allocated emergency memory associated with the emergency allocator 246 is sufficient to perform the corresponding operations, the cleanup/rollback operation will succeed. Thereafter, the emergency allocator 246 can be unassigned/disassociated from the thread after completion of the operation. Other threads running in parallel that also face out-of-memory situation during cleanup/rollback operation will, in some implementations, need to wait until the emergency allocator 246 is unassigned from the other thread and free to use. In some implementations, there are multiple emergency allocators 246 to enable multiple threads of operations to use separate and dedicated pre-allocated memory in parallel.

While the above was described in connection with rollback/cleanup operations, the emergency allocator 246 can be used in connection with other operations that need to be performed in order to guarantee performance of the data storage application 104. Such operations need to ensure that all emergency memory allocations are only temporary and will be freed right after the corresponding operation before releasing the emergency allocator.

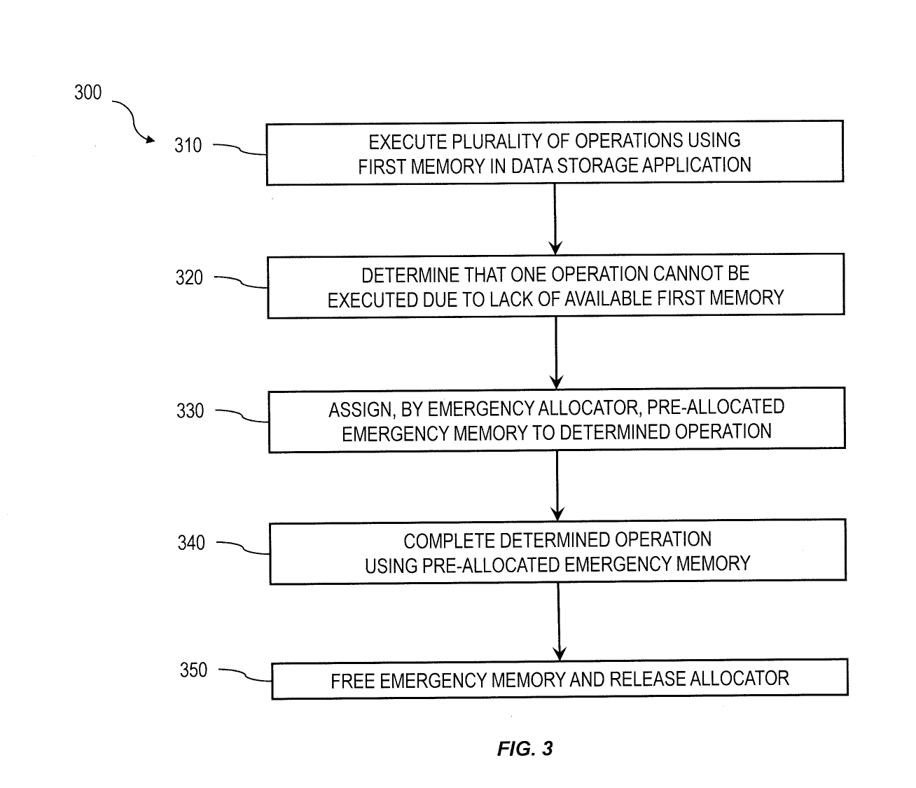

FIG. 3 is a process flow diagram illustrating a method 300 in which, at 310, a plurality of operations using first memory in a data storage application. Thereafter, at 320, it is determined that one of the operations cannot be executed due to a lack of available first memory. At this point, at 330, an emergency allocator assigns pre-allocated emergency memory to the determined operation. This pre-allocated emergency memory is separate and distinct from the first memory (i.e., it can be segregated). Using this pre-allocated emergency memory, the determined operation, at 340, is completed. Then, at 350, the emergency memory is freed and the emergency allocator is released to use by another operation.

Aspects of the subject matter described herein can be embodied in systems, apparatus, methods, and/or articles depending on the desired configuration. In particular, various implementations of the subject matter described herein can be realized in digital electronic circuitry, integrated circuitry, specially designed application specific integrated circuits (ASICs), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. A client and server are generally, but not exclusively, remote from each other and typically interact through a communication network, although the components of the system can be interconnected by any form or medium of digital data communication. Examples of communication networks include, but are not limited to, a local area network (“LAN”), a wide area network (“WAN”), and the Internet. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail herein, other modifications or additions are possible. In particular, further features and/or variations can be provided in addition to those set forth herein. For example, the implementations described above can be directed to various combinations and sub-combinations of the disclosed features and/or combinations and sub-combinations of one or more features further to those disclosed herein. In addition, the logic flows depicted in the accompanying figures and/or described herein do not necessarily require the particular order shown, or sequential order, to achieve desirable results. The scope of the following claims may include other implementations or embodiments.

What is claimed is:

1. A method comprising:
executing a plurality of operations using first memory in a data storage application;
determining that one of the operations cannot be executed due to a lack of available first memory;
assigning, by an emergency allocator, pre-allocated emergency memory to the determined operation, the pre-allocated emergency memory being separate and distinct from the first memory; and
completing the determined operation using the pre-allocated emergency memory.

2. A method as in claim 1, wherein the operations comprise rollback operations.

3. A method as in claim 1, wherein the operations comprise cleanup operations.

4. A method as in claim 1, wherein it is determined that one of the operations cannot be executed due to a lack of available first memory based on a thrown exception.

5. A method as in claim 1, wherein each operation is performed by a separate thread, and wherein the pre-allocated emergency memory is assigned to the corresponding thread for the determined operation.

6. A method as in claim 5, wherein the emergency allocator only assigns the pre-allocated emergency memory to one thread at a time.

7. A method as in claim 1, wherein the data storage application uses shadow paging to write a transactionally-consistent savepoint.

8. A method as in claim 7, wherein a data backup corresponding to the plurality of executed transactions comprises a copy of all data pages contained with a particular savepoint.

9. A method as in claim 1, wherein the data storage application comprises an in-memory database.

10. A method as in claim 1, wherein the first memory is heap memory.

11. A method as in claim 1, further comprising:
freeing the pre-allocated emergency memory and releasing the emergency allocator after completion of the determined operation.

12. A non-transitory computer program product storing instructions, which when executed by at least one data processor, result in operations comprising:
executing a plurality of operations using first memory in a data storage application;
determining that one of the operations cannot be executed due to a lack of available first memory;
assigning, by an emergency allocator, pre-allocated emergency memory to the determined operation, the pre-allocated emergency memory being separate and distinct from the first memory; and
completing the determined operation using the pre-allocated emergency memory.

13. A computer program product as in claim 12, wherein the operations comprise rollback operations and cleanup operations.

14. A computer program product as in claim 12, wherein it is determined that one of the operations cannot be executed due to a lack of available first memory based on a thrown exception.

15. A computer program product as in claim 12, wherein each operation is performed by a separate thread, and wherein the pre-allocated emergency memory is assigned to the corresponding thread for the determined operation.

16. A computer program product as in claim 15, wherein the emergency allocator only assigns the pre-allocated emergency memory to one thread at a time.

17. A computer program product as in claim 12, wherein the data storage application uses shadow paging to write a transactionally-consistent savepoint, wherein a data backup corresponding to the plurality of executed transactions comprises a copy of all data pages contained with a particular savepoint.

18. A computer program product as in claim 12, wherein the data storage application comprises an in-memory database.

19. A computer program product as in claim 12, wherein the operations further comprise:
freeing the pre-allocated emergency memory and releasing the emergency allocator after completion of the determined operation.

20. A system comprising:
a data storage application comprising an in-memory database;
one or more data processors; and
memory storing instructions, which, when executed by at least one data processor, result in operations comprising:
executing a plurality of operations using first memory in the data storage application;
determining that one of the operations cannot be executed due to a lack of available first memory;
assigning, by an emergency allocator, pre-allocated emergency memory to the determined operation, the pre-allocated emergency memory being separate and distinct from the first memory; and
completing the determined operation using the pre-allocated emergency memory.
